(19) United States
(12) Patent Application Publication
(10) Pub. No.: US 2013/0340684 A1
(43) Pub. Date: Dec. 26, 2013

(54) Dog Training and Exercise Apparatus

(71) Applicant: Fidot Depot, LLC, Rancho Cordova, CA (US)

(72) Inventors: William G. Townsend, Sacramento, CA (US); Larry H. Jacobs, Fair Oaks, CA (US)

(21) Appl. No.: 13/925,580

(22) Filed: Jun. 24, 2013

Related U.S. Application Data
(60) Provisional application No. 61/663,045, filed on Jun. 22, 2012.

(51) Int. Cl. A01K 15/02

(52) U.S. Cl. CPC A01K 15/025
USPC 119/708

(57) ABSTRACT

A pet exercise and training apparatus is described, the apparatus comprising a hollow tube comprising a first end and a second end, the first end comprising a handle assembly comprising a cord winding area, cord retention notch, and cord toggle. A cord runs longitudinally the length of the tube from the first end to the second end, exiting an aperture on the second end. A toy attached to the cord provides a pet exercise and training apparatus capable of use in small spaces, and which may be employed by persons of limited mobility. Additionally, the present application presents an apparatus capable of employing food based incentives.

### RELATED APPLICATIONS

This application is a Nonprovisional Application of and claims priority to U.S. Provisional Patent Application 61/663045, filed Jun. 22, 2012, which is incorporated herein in its entirety as if set out in full.

### BACKGROUND AND DESCRIPTION OF THE RELATED ART

1. Field of the Invention

The present invention relates generally to the field of toys, exercise devices, and training devices for pets. In particular, the invention provides a dog exercise and training apparatus.

2. Background

The health and happiness of a pet, and in particular a dog, is dependent upon several factors. One of the most important factors to the health and happiness of a dog is that the dog receives an adequate level of exercise. Regular exercise helps a dog maintain healthy muscles, joints, and other bodily systems, as well as maintain a healthy level of body fat. Regular exercise can also have beneficial effects on the mental state of the dog. Dogs that do not exercise sufficiently are not only more likely to suffer from poor health, but also are more likely to have a depressed state of mind, and manifest various undesirable behaviors.

A second important factor to the health and happiness of a pet, and in particular a dog, is training For instance, it is important that a dog receive adequate training so that a harmonious relationship may be achieved between the dog and the dog's owner, as well as between the dog and other dogs or humans. It is an exceptional dog that achieves such a harmonious relationship without investments in training

There is thus little dispute that both a dog and its relationship with its owner benefit from the training and regular exercise of the owner's dog. Despite this, it is unfortunately all too common a situation that an owner's dog is left under-exercised, under-trained, or both. The reasons for this are as myriad, with lack of time, bad weather, lack of energy of the owner and lack of sufficiently large and open spaces are commonly cited. The last two cited difficulties are unfortunately becoming increasingly common. Owner participation in the exercise of a dog can often mean long runs with the dog, or at the minimum long bouts of time throwing an object for the dog to retrieve. Even if the owner is willing to engage the dog for a sufficient amount of time, today's urban areas often simply lack the open space that is often required. Yards are frequently small or non-existent, and off leash city parks are often small and tightly enclosed, preventing the long sprints that put adequate demands on a dogs cardiovascular system. Finally, dog owners who have limited mobility, such as the elderly or owners who are confined to a wheelchair, are often less able to sufficiently exercise their dog.

Many prior art apparatuses for exercising and/or training a dog exist, however, all of them suffer from one or more of the following limitations or disadvantages: requiring large open spaces, requiring an able bodied user, and requiring large investments of time and energy to acquaint the dog with the apparatus.

In view of the foregoing disadvantages inherent in the prior art dog training and exercise apparatuses, it is thus a first object of the invention to provide a dog training and exercise apparatus that may be employed in limited spaces.

It is a second object of the invention to provide a dog training and exercise apparatus that will very quickly stress the cardiovascular system of a dog whilst not requiring a large amount of space.

It is a third object of the invention to provide a dog training and exercise apparatus that may be utilized by a person with limited mobility.

It is a fourth object of the invention to provide a dog training and exercise apparatus that allows for the use of a food-based incentive for the dog interacting with the apparatus.

Additional objects and advantages of the present invention will become obvious to the reader and it is intended that these objects and advantages be within the scope of the present invention.

### SUMMARY OF THE DISCLOSURE

To minimize the limitations found in the prior art, and to minimize other limitations that will be apparent upon the reading of this specification, the preferred embodiment of the present invention provides a dog training and exercise apparatus.

The present invention relates generally to a dog exercise and training apparatus requiring only a relatively small amount of physical space, and which may be employed by persons of limited mobility. Additionally, the present invention relates to a dog training apparatus that requires minimal effort by the operator. The present invention further relates to a dog exercise and training apparatus employing food based incentives.

The apparatus comprises a first tube and a second tube that are lightweight, strong, and stiff. The tubes are configured to interface and join together through actuation of a push button mechanism. An end of the first tube comprises a handle assembly, which itself comprises a textured grip, which in a preferred embodiment comprises contoured foam. The handle assembly further comprises a cord winding area having a preferably frustoconical shape and configured such that cord may be wound around it. The cord winding area further comprises a plurality of cord retention notches, of which there are preferably at least four, and around which the cord may be wound. In use, the cord may be adjusted such that the desired length of cord exits the second end of the second tube and is then fixed at that length by passing the cord through the cord retention notch, winding the cord around the cord winding area, and finally passing the cord through a second cord retention notch.

The handle assembly may further comprise a cord toggle, which when actuated allows the cord to pass through the toggle, but when not actuated, does not allow the cord to pass through the toggle but instead maintains it in a stationary position relative to the cord. The base of the handle further comprises a hole therethrough, and which allows the cord to pass through the hole and through the center of the first tube. An end of the second tube further comprises a cover, which itself comprises a hole to allow passage and movement of the cord.

The pet exercise and training apparatus may further comprise a toy, and preferably a dog toy comprising fabric and stuffing. As expected, the design choice of the toy is up to the personal preference of the owner and the dog. The toy further comprises an attachment means, such as hook and loop configured such that the toy may be attached to a loop located at the end of the cord. The toy further may comprise a food-based incentive notch, in which a user of the apparatus may place various food-based incentives such as dog treats.

Preferably, the first tube and second tube are hollow, thereby allowing the cord to pass therethrough longitudinally such that the cord exits the end of the second tube.

In operation, the device is used with a casting type motion, and allows an operator to precisely control of an attached toy within a limited space. Using this motion only a flick of the operator's wrist is required to generate dramatic changes in direction of a toy attached to one end of the cord. Further, through slight changes in the angle of the wrist, the user can quickly manipulate, move, throw, and change the direction of the toy in mid-flight or along the ground. The elongated nature of the device and pivotal connection between the toy and the arm of the operator enables the operator to multiply the distance and speed at which toy travels with respect to the arm of the operator. Importantly, the device may be used by an operator in the seated position.

When in use, the cord may travel freely along the entire length of the apparatus unless the cord has been fixed to the handle assembly by use of the cord retention notches and the cord winding area. The cord winding area can either security affix the cord, or allow any excess length of cord to be neatly stored such that it will not tangle or otherwise cause problems for the user.

The apparatus disclosed allows a user to exercise and train his or her pet in limited spaces such as driveways, apartment common area, or within a small yard. Importantly, the system also allows a user of limited mobility, such as a user confined to a wheelchair, to exercise and train his or her pet.

These and other advantages and features of the present invention are described with specificity so as to make the present invention understandable to one of ordinary skill in the art.

### BRIEF DESCRIPTION OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention, thus the drawings are generalized in form in the interest of clarity and conciseness.

FIG. 1 is a perspective view of the apparatus in use according to a preferred embodiment of the invention;

FIG. 2 is a perspective view of the apparatus according to the preferred embodiment of the invention;

FIG. 3 is a top view of the toy portion of the apparatus according to the preferred embodiment of the invention;

FIG. 4 is a top view of the toy portion of the apparatus with a food based incentive inserted into the toy according to the preferred embodiment of the invention;

FIG. 5 is a perspective view of the joint and fastening mechanism of the apparatus according to the preferred embodiment of the invention;

FIG. 6 is a detailed perspective view of the handle assembly of the apparatus according to the preferred embodiment of the invention;

FIG. 7 is a perspective view of the cord winding area and cord retention notches according to the preferred embodiment of the invention;

FIG. 8 is a figure eight knot according to an alternative embodiment of the invention.

FIG. 9 is a schematic view of the apparatus according to the preferred embodiment of the invention.

### DETAILED DESCRIPTION OF THE DRAWINGS

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized and changes may be made without departing from the scope of the present invention.

Various inventive features are described below that can each be used independently of one another or in combination with other features. However, any single inventive feature may not address any of the problems discussed above or only address one of the problems discussed above. Further, one or more of the problems discussed above may not be fully addressed by any of the features described below.

A pet exercise and training apparatus which may be used in small spaces, by persons of limited mobility, and which enables the use of food-based incentives is described herein.

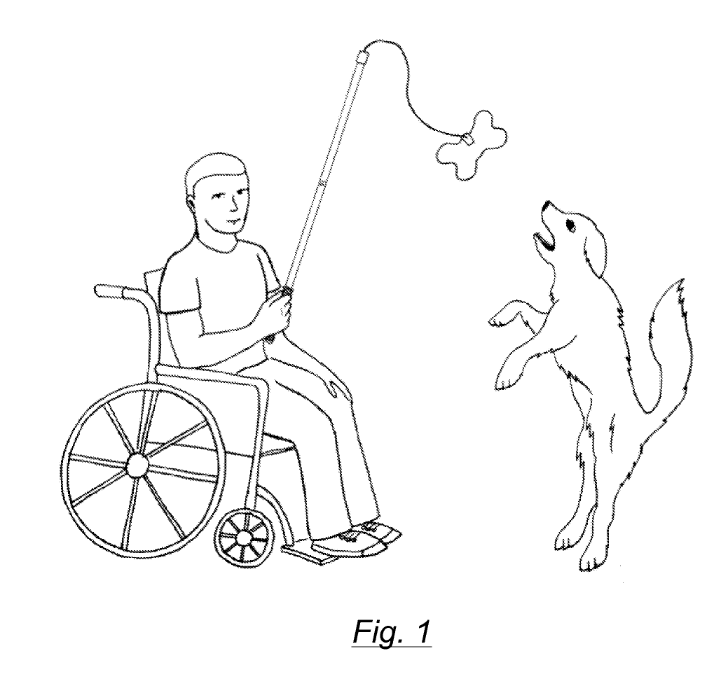

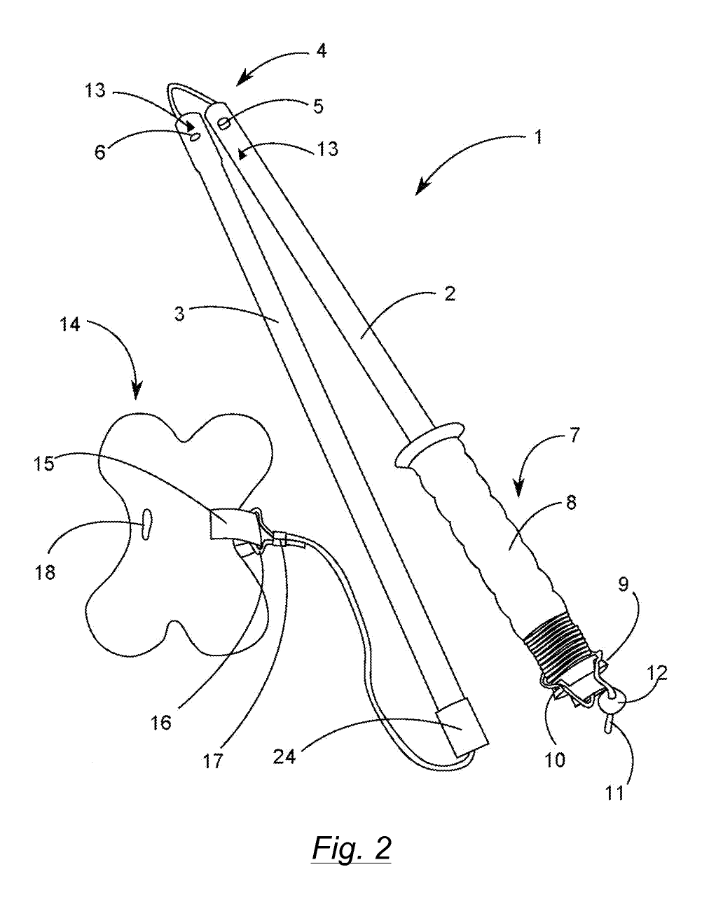

An overview of the apparatus in use according to a preferred embodiment of the invention is shown in FIG. 1. Turning to FIGS. 2-4, the preferred embodiment of the pet exercise and training apparatus 1 comprises a first tube 2 and a second tube 3. In the preferred embodiment, the first and second tubes are made of aluminum, but may be made of any suitable material which is lightweight, strong, and stiff such as but not limited to other metals, fiber composites, wood, and plastic.

The first tube 2 has a first tube first end and a first tube second end. The first tube first end comprises a male half 5 of a joint and fastening mechanism 4 configured for engagement with a second tube second end. In a preferred embodiment the male half 5 comprises a spring actuated push button which will, when the apparatus is assembled, interface with a female half 6 of the joint and fastening mechanism 4 located on the first end of the second tube 3. The spring actuated push button may be replaced with any joint and fastening mechanism known in the art that is suitable to releaseably join together two tube shaped objects in an end-to-end configuration. In an alternative embodiment, first tube 2 and second tube 3 are not separate tubes but instead are a single integral tube. A downside to this alternative embodiment is that the device does not break down for easy transport and storage.

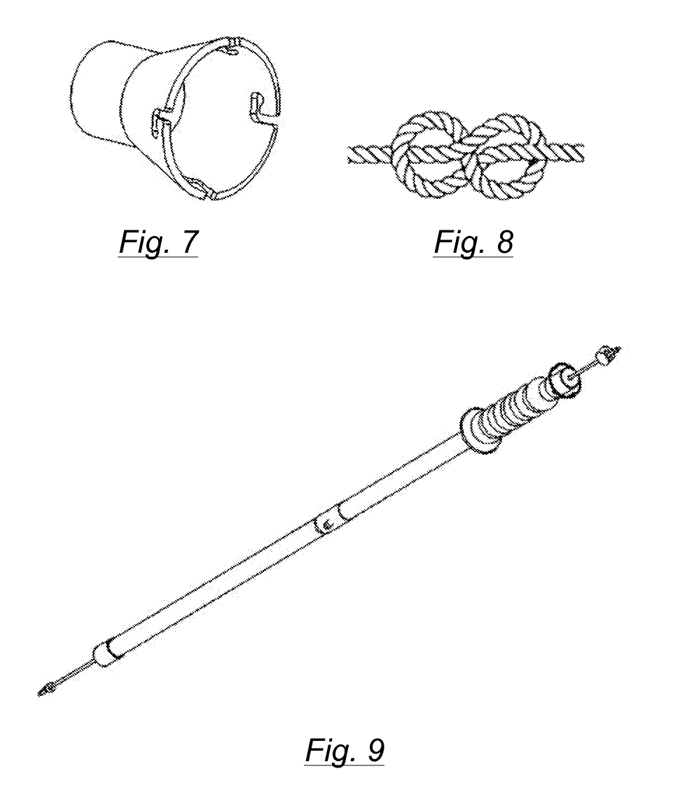

The second end of the first tube 2 comprises a handle assembly 7. The handle assembly 7 comprises a textured grip 8, which in a preferred embodiment comprises contoured foam. The handle assembly 7 further comprises a cord winding area 9. Cord winding area 9 is preferably generally of a frustoconical shape and is configured such that cord 11 may wound around it. Cord winding area 9 further comprises cord retention notches 10, shown in detail in FIG. 7. In the preferred embodiment the cord winding area 9 comprises four cord retention notches 10. Other embodiments may comprise a different number of cord retention notches 10 or other suitable means for securing the cord such that the length of the cord is adjustable. The handle assembly further comprises, in a preferred embodiment, a cord toggle 12. Cord toggle 12 may be any toggle as known in the art which when actuated allows the cord to pass through the toggle, but when not actuated, does not allow the cord to pass through the toggle but instead maintains it in a stationary position relative to the cord. Cord toggle 12 thus acts as stop for the cord, that when engaged prevents slippage of the cord 11 beyond where the toggle abuts a cord retention notch 10. Thus, the length of the cord extending out from second tube 3 is adjustable.

The handle assembly 7 further comprises a hole (not shown in FIG. 2) in its base, which allows cord 11 to pass through said hole and thence through the center of the first tube 2.

As described above and in the attached figures, second tube 3 comprises a second tube first end and a second tube second end. The second tube second end comprises female half 6 of said joint and fastening mechanism 4. In a preferred embodiment female half 6 comprises a hole that, when the apparatus is assembled, interfaces with the male half of the joint and fastening mechanism 4 located on the first end of the first tube 2. The second end of the second tube, in this preferred embodiment, may be of slightly larger diameter than the remainder of the first and second tubes and particularly the first end of first tube 2, so as to accommodate the first tube first end when assembled. This larger diameter thus allows the first end of second tube 6 to fit snugly around the first end of first tube 2 when the apparatus is assembled and joint and fastening mechanism 4 is engaged.

The connecting ends of both the first and second tubes, in a preferred embodiment, each further comprise alignment markings which assist a user of the apparatus in engaging the joint and fastening mechanism 4, as shown best by the triangles arrows in FIG. 5.

The first end of second tube 3 further comprises a cover 24. Cover 24 preferably comprises a hole to allow passage and movement of the cord 11. Cover 24 is preferably made of plastic, but may be made of any suitable material as known in the art such as but not limited to metal, cloth, wood, and fiber composite.

The pet exercise and training apparatus further comprises a toy 14. In the preferred embodiment the toy is a dog toy comprising fabric and stuffing and in the shape of a bone, although the design choice of the toy may include any suitable shape and any suitable material known selected by the owner or the preference of the dog.

The toy may further comprise a food-based incentive notch 18, in which may be placed by a user of the apparatus various food-based incentives such as but not limited to dog treats (see FIG. 4). The toy my further comprise powdered scent that will attract the attention of the dog during use.

Returning to FIG. 2, cord 11 has a first and second end, the first end may comprise a loop 16, which in a preferred embodiment is created by use of a compression sleeve 17. In alternative embodiments the loop may be created by use of any technique or device known in the art such as but not limited to a knot. One such embodiment a figure eight knot is used, as shown in FIG. 9.

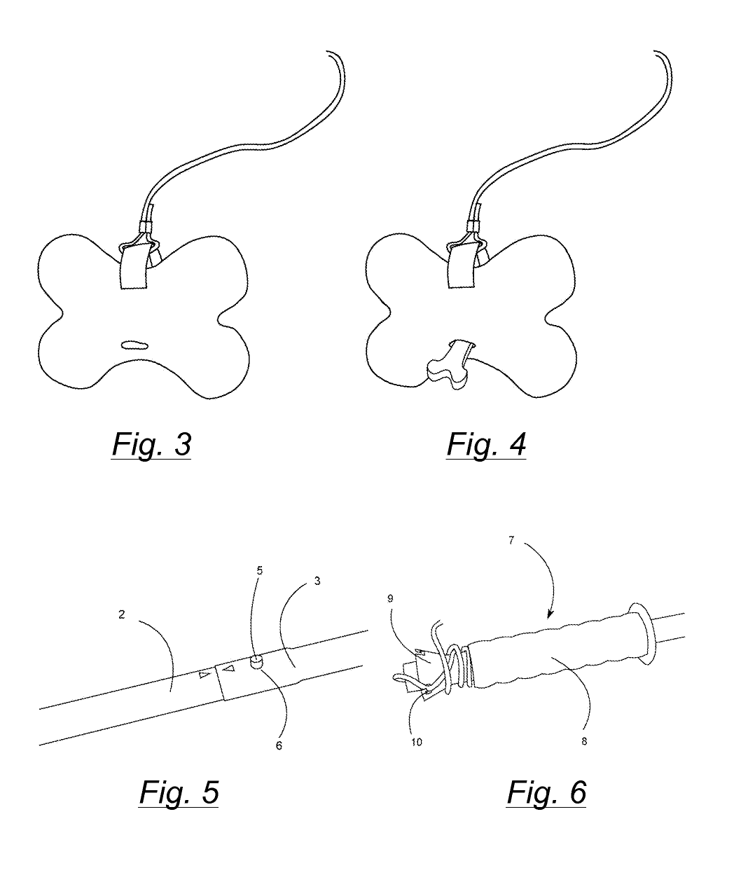

The toy comprises an attachment means 15 for securing the toy to the end of the cord 11. In a preferred embodiment attachment means 15 comprises hook and loop tape configured such that the toy may be attached to a loop 16 located at the end of the cord 11. The hook and loop embodiment is best depicted in FIGS. 3 and 4.

The cord is secured to the toy 14 by attachment means 15 securing around the loop 16. In alternative embodiments the cord may be attached to the toy by any means known in the art such as but not limited to buckles, carabineers, and knots. In other embodiments toy 14 (or other objects) may be secured to cord 11 through other securing means known in the art.

Preferably, first tube 2 and second tube 3 are hollow, thereby allowing cord 11 to pass therethrough longitudinally as shown in FIG. 2. As shown, cord 11 may exit the second end of first tube 2 via the hole in the handle assembly 7.

Turning now to FIG. 5, an exemplary joint and fastening mechanism (not labeled in this Fig.) of the preferred embodiment of the invention is shown in greater detail. As may be seen the first end of the first tube 2 has been inserted into the first end of the second tube 3, and the spring actuated push button 5 has interfaced with a hole 6. Once the joint and fastening mechanism has been engaged as shown the apparatus is ready for use in exercising or training a pet.

FIG. 6 depicts a detailed view of the handle assembly 7 of the preferred embodiment. As may be more clearly seen in this figure, the cord winding area 9 is configured such that cord 11 may be partially secured when wound around it. Cord winding area 9 further comprises cord retention notches 10 to further secure the cord 11. In the preferred embodiment, cord winding area 9 comprises four cord retention notches 10. Other embodiments may comprise a different number of cord retention notches 10 or other suitable means for quickly and releasably securing cord 11 to apparatus 1. In use, cord 11 is adjustable by the user such that the desired length of cord exits the second end of the second tube 3 and is then fixed at that length by passing the cord through the cord retention notch 10, winding the cord around the cord winding area 9, and finally passing the cord through a second cord retention notch 10 (as shown in FIG. 2).

In a preferred embodiment the apparatus is approximately 46 inches in length when assembled. Less preferably, the apparatus may be between 20 inches and 90 inches in length. In alternative embodiments the apparatus may be of other lengths. Further, in other embodiments the device comprises a single integral hollow tube, is not capable of disassembly, and has an overall length as described above.

In use, cord 11 may travel freely within the tubes and along the entire length of the apparatus, unless the cord has been fixed to the handle assembly by use of the cord retention notches 10 and the cord winding area 9 and cord toggle 12. The cord winding area 9 allows cord 11 to be more securely fixed, and also allows any excess length of cord 11 to be neatly stored such that it will not tangle or otherwise cause problems for the user.

The apparatus allows a user to easily “throw” the attached toy using only a flick of the wrist and the accompanying whip-like motion of the cord and toy that follows. The apparatus enables a user to quickly manipulate, move, throw, and change direction of the toy in mid-flight or along the ground. The elongated nature of the device and pivotal connection between toy 14 and the arm of the operator enables the operator to multiply the distance and speed at which toy 14 travels with respect to the arm of the operator. The level of multiplication is dependent on the apparatus length, and the length of exposed cord. For instance, in some configurations for each distance traveled by the handle assembly 7 via the wrist of the operator, the toy 14 travels at least four times said distance. If the device is longer or if additional cord is released from said second tube first end the toy 14 may travel at least eight times said distance.

The apparatus disclosed allows a user to exercise and train his or her pet in limited spaces such as driveways, apartment or building common areas, or a small yard, or even a large room.

The novel design of the apparatus also allows a user of limited mobility, such as a user confined to a wheelchair, to exercise and train his or her pet, eliminating the need for the user to recover a thrown toy when not done so by the pet. The aforementioned lever effect and hence the apparatus as a system allows a user in a stationary position but capable of arm movement to move the attached toy through a large range/area and with great precision and speed, thus allowing for effective exercise and training of the pet.

If the pet exercise and training apparatus 1 has been optionally configured to accept a food-based incentive, the dog or pet will be enticed into initial play so as to quickly familiarize itself with the apparatus and its use. Thereafter, the optionally placed food-based incentive may be removed from the device and the dog, now familiar with the device and its use, will continue to play and exercise.

The apparatus may be readily integrated into a pet training regimen. “Stay”, “fetch”, “drop”, etc. are especially effective commands that are easily taught in conjunction with the use of the apparatus. The joy, anticipation, and excitement of the “chase” contrasts starkly with the trainer's overriding commands, providing a very effective and efficient training environment for any dog.

The foregoing description of the preferred embodiment of the present invention has been presented for the purpose of illustration and description. It is not intended to be exhaustive or to limit the invention to the precise form disclosed. Many modifications and variations are possible in light of the above teachings. It is intended that the scope of the present invention not be limited by this detailed description, but by the claims and the equivalents to the claims appended hereto.

We claim:

1. A pet exercise and training apparatus, the apparatus comprising:
a. a hollow first tube having a first tube first end and a first tube second end;
b. a hollow second tube having a second tube first end and a second tube second end, wherein the first tube first end is connected to the second tube second end;
c. a handle assembly integral with said first tube second end, the handle assembly comprising:
i. an open center with a cord running therethrough;
ii. a cord winding area;
iii. at least one cord retention notch; and
iv. a cord toggle;
d. a cord passing through said handle assembly, said first tube, and said second tube; and
e. a toy attached to a first end of said cord;
f. wherein a second end of said cord is wound around said cord winding area and secured in place by said cord retention notch.

2. The pet exercise and training apparatus according to claim 1 comprising a plurality of cord retention notches.

3. The pet exercise and training apparatus according to claim 2 comprising four cord retention notches.

4. The pet exercise and training apparatus according to claim 1, wherein said handle assembly comprises a textured grip.

5. The pet exercise and training apparatus according to claim 1, further comprising a cover on the first end of said second tube, the cover comprising a hole therethrough and through which said cord extends.

6. The pet exercise and training apparatus according to claim 1, wherein said toy comprises a food retention notch.

7. A pet exercise and training apparatus, the apparatus comprising:
a. a hollow tube having a first end and a second end;
b. an opening at said first end and an opening at said second end through which a cord extends, the cord having a first end and a second end;
c. a handle assembly integral with said second end, the handle assembly comprising:
i. an open center with a cord running therethrough;
ii. a cord winding area;
iii. at least one cord retention notch; and
iv. a cord toggle; and
d. a toy attached to a first end of said cord;
e. wherein a second end of said cord is wound around said cord winding area and secured in place by said cord retention notch.

8. The pet exercise and training apparatus according to claim 7 comprising a plurality of cord retention notches.

9. The pet exercise and training apparatus according to claim 8 comprising four cord retention notches.

10. The pet exercise and training apparatus according to claim 7, wherein said handle assembly comprises a textured grip.

11. The pet exercise and training apparatus according to claim 7, further comprising a cover on the first end of said second tube, the cover comprising a hole therethrough and through which said cord extends.

12. The pet exercise and training apparatus according to claim 7, wherein said toy comprises a food retention notch.

13. A method of exercising and training a dog using a pet exercise and training apparatus, the method comprising the steps of:
a. Providing a pet exercise and training apparatus comprising:
i. a hollow first tube having a first tube first end and a first tube second end;
ii. a hollow second tube having a second tube first end and a second tube second end, wherein the first tube first end is connected to the second tube second end;
iii. a handle assembly integral with said first tube second end, the handle assembly comprising:
1. an open center with a cord running therethrough;
2. a cord winding area;
3. at least one cord retention notch; and
4. a cord toggle;
iv. a cord passing through said handle assembly, said first tube, and said second tube;
v. a toy attached to a first end of said cord;
vi. wherein a second end of said cord is wound around said cord winding area and secured in place by said cord retention notch;
b. gripping said handle; and
c. moving said handle such that said handle travels a handle distance and said toy travels a toy distance, wherein said toy distance is at least four times said handle distance.

14. The method according to claim 13, wherein said pet exercise and training apparatus comprises a plurality of cord retention notches.

15. The method according to claim 14, wherein said pet exercise and training apparatus comprises a four cord retention notches.

16. The method according to claim 13, wherein said handle assembly comprises a textured grip.

17. The method according to claim 13, wherein said pet exercise and training apparatus comprises a cover on the first end of said second tube, the cover comprising a hole therethrough and through which said cord extends.

18. The method according to claim 13, wherein said toy comprises a food retention notch.

19. The method according to claim 13 wherein said toy distance is at least eight times said handle distance.
